(19) United States
(12) Patent Application Publication
(10) Pub. No.: US 2013/0020735 A1
(43) Pub. Date: Jan. 24, 2013

(54) Method for Milling Long Fiber Reinforced Composite Plastic

(71) Applicants: Wolfgang Hintze, Hamburg (DE); Dirk Hartmann, Hamburg (DE); Christoph Schütte, Winsen (DE)

(72) Inventors: Wolfgang Hintze, Hamburg (DE); Dirk Hartmann, Hamburg (DE); Christoph Schütte, Winsen (DE)

(73) Assignees: TECHNISCHE UNIVERSITÄT HAMBURG-HARBURG, Hamburg (DE); TUTECH INNOVATION GMBH, Hamburg (DE)

(21) Appl. No.: 13/521,848

(22) PCT Filed: Jan. 7, 2011
(86) PCT No.: PCT/EP11/00042

§ 371 Date: Oct. 9, 2012

(30) Foreign Application Priority Data
Jan. 12, 2010 (DE) 10 2010 004 570.5

(51) Int. Cl. B29C 67/00

(52) U.S. Cl. 264/162

(57) ABSTRACT

A method for milling long fibre reinforced composite plastics having at least one unidirectional top layer using a rotating milling tool, wherein work piece and tool are moved in an advancing movement parallel to the work piece cutting face relative to each other, and wherein
there is an edge fibre separation angle on the work piece of 0°≦θ_{edge}≦90°, and
the blade of the tool mills the component edge in synchronization.

### CROSS-REFERENCE TO RELATED APPLICATIONS

This is a national stage application of PCT/EP2011/000042, filed on Jul. 12, 2012, the entire content of which are hereby incorporated by reference.

### STATEMENT REGARDING FEDERALLY SPONSORED RESEARCH

Not applicable.

### BACKGROUND OF THE INVENTION

The present invention relates to a method for milling long fibre reinforced composite plastics having at least one unidirectional top layer.

In the mechanical processing of long fibre reinforced composite plastics, no delamination occurs in the component at contour edges or shoulders when the blade is faultless and sharp-edged. The fibres are completely separated from the component's top layer, and the component surface features no spalling or chipping off. With increasing tool wear, which is distinguished above all by increasing blade rounding when fibre composite plastics are machined by stock removal, delamination can occur. Component delamination can also occur when the tool blade has blade rounding in the work-sharp condition, which is the case in (diamond-) coated tools, for instance. Delamination causes post-machining and higher component cost, and it negatively affects the mechanical properties of the fibre composite component. Additional top layers for avoiding delamination, like layers from tissue or GRP e.g., are undesired for reasons of lightweight construction.

In Colligan K. et al “Delamination in surface plies of graphite/epoxy caused by the edge trimming process”, published in Processing and manufacturing of composite materials, vol. 27, 1991, it is described that different forms of delamination can occur. It is notably differentiated between fibre overhang, break-out of the top layers and loose, irregularly disposed overhanging fibres.

From Hocheng, H. et al “Preliminary study on milling of unidirectional carbon fibre-reinforced plastics” published in Composites manufacturing, vol. 4, No. 2, 93, pages 103-108, it is known that the fibre orientation exerts an influence on the rise of delaminations. While no delamination occurs and even cutting faces are produced when a 0°-orientation is contour milled, the fibres are not separated completely in 90° or 135° orientation. The rise of delaminations can be obviated by a purposeful layer structure. A symmetrical structure should be selected and strongly different contraction numbers should be avoided.

From Ramulu M. “Machining and surface integrity fibre-reinforced plastic composites”, Sadhana, vol. 22, part 3, pages 149-772, 1997 it has become known that the top layer is decisive for the rise of delaminations.

From the document DE 10 2007 027 461 A1, a method for machining a work piece from a fibre composite material is known, notably from a fibre plastics composite. In order to avoid damage of the fibres in the machining, it is proposed to use a cutting angle of <10°.

When long fibre reinforced composite plastics having a unidirectional top layer are milled, a special problem occurs when contour machining is to be made. The known approaches for improving the component quality in a two-step process of scrubbing and finishing fail then when delamination has occurred. It has been shown that fibres loosened in the scrubbing can not or only insufficiently be removed in a subsequent finishing process.

### BRIEF SUMMARY OF THE INVENTION

The present invention is based on the task to provide a method for edge trimming work pieces of long fibre reinforced composite plastics having a unidirectional top layer without delamination and fibre overhang, and to avoid sumptuous post-machining on the produced work piece edge.

The method of the present invention is related to the machining of long fibre reinforced composite plastics having at least one unidirectional top layer. In at least one top layer, such a work piece has fibres which all in common extend in one direction. According to the present invention, the machining takes place by milling using a rotating tool, wherein work piece and tool are moved relative to each other in an advancing movement parallel to the work piece cutting face to be produced. The work piece cutting face to be produced is that edge which arises on the work pieces by the milling process. According to the present invention, this method is characterised by two conditions. The first condition relates to the edge fibre separation angle at the work piece edge to be made. According to the present invention, the edge fibre separation angle must be between 0° and 90° in the entire milling process. The second condition for avoiding the delamination of the top layer is that the blade of the tool moves on the work piece edge to be made in the direction of the vector of the work piece's advancing direction. In the terminology of those skilled in the art, such a movement is also designated as “synchronisation milling”.

By maintaining the condition for the edge fibre separation angle at the work piece edge to be made in the synchronisation milling of the method of the present invention, the rise of fibre residues and delamination of the top layer can be avoided. By selecting the cutting direction along the work piece contour to be machined according to the present invention such that the fibre orientation and the vector of the work piece advancing direction on the work piece edge to be made are always directed opposite to the unidirectional top layer or at least perpendicular to the former, i.e. include an edge fibre separation angle θ_{edge} of 0°≦θ_{edge}≦90°, fibre overhang can be avoided. In order to maintain the condition of the present invention to mill the work piece edge to be made always at an acute edge fibre separation angle 0°≦θ_{edge}≦90°, it may be necessary that the machining of the work piece has to be made area by area, in contour- or perimeter milling in particular, geometrical conditions can occur that permit only area by area machining of the work piece. The edge fibre separation angle θ_{edge} differs from the fibre separation angle in that the angle between the fibre orientation, that is to say the longitudinal direction of the fibre, and the vector of the cutting velocity on the work piece edge to be made is contemplated, whereas the fibre separation angle continuously changes in its value across the cutting path.

In the preferred embodiment, addition of coolants takes place during the milling process. In doing so, it is possible to add a fluidic or a gaseous coolant. Alternatively, it is also possible to add coolant in the form of an exhalation in the milling process.

In a further, preferred embodiment, different areas are defined for a work piece edge to be milled, such that the edge fibre separation angle is 90° at the transitions of the areas. The cutting direction and the advancing direction are now selected for each area such that the edge fibre separation angle θ is always 0°≦θ_{edge}≦90° and the work piece edge is produced in synchronization. Such a selection of the cutting- and advancing direction permits to use one single tool for machining the entire work piece edge, wherein a spindle arrangement or the work piece can be reversed between the areas.

In a second, preferred embodiment of the method of the present invention, a clockwise rotating tool and a counter-clockwise rotating tool are used. The cutting direction and the advancing direction are selected such that for work piece edges having areas of different fibre orientation, always the tool with the suitable rotational direction is used, by which the admissible range of the edge fibre separation angle is maintained and the work piece edge is always milled in synchronization.

In a further embodiment, both tools are arranged on a tool spindle and are driven by it. According to this embodiment of the method of the present invention, which is particularly suited for the utilization of robot machines, the area by area milling of the work piece edge takes place by changing the respective tool cutting direction and advancing direction, without braking down the tool spindle.

### BRIEF DESCRIPTION OF THE SEVERAL VIEWS OF THE DRAWINGS

The method of the present invention will be explained in more detail by an example of its realisation in the following. The figures show:

FIG. 1 delaminations in dependence of the tool wear,

FIG. 2 delamination when milling with a worn tool,

FIG. 3 the fibre separation angle when milling in the machining of an edge fibre separation angle of θ_{edge}=45°.

FIG. 4 Change of the separation angle with the advancing path on a single fibre,

FIG. 5 systematics for the rise of delaminations for selected edge fibre separation angles θ_{edge},

FIG. 6 adjustment of the cutting direction by the spindle arrangement,

FIG. 7 adjustment of the edge fibre separation angle by reversing the component, and

FIG. 8 machining of a work piece having asymmetric orientation of front- and rear top layer.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

Carbon fibre reinforced plastics (CFRP) are increasingly utilized in the aerospace industries. After completed curing, the dimensional fit of the components is achieved by edge trimming processes. For this, milling processes are used above all, in which the component contour is made by perimeter milling. In such milling processes, delaminations in the form of fibre hangover and break-out on the top layer of the machined component edges can occur. Here, the fibres are detached from the composite by the loads of the blade engagement, and are not separated in a defined way due to lack of support.

In the realisation examples for explaining the present invention, slits are milled into unidirectionally reinforced CFRP samples having HT fibres and an epoxy matrix. This procedure yields information about the arising location as well as about the propagation of the delaminations, because the slit end is retained. A double-edged PCD-milling tool with straight grooves was used for machining the CFRP samples in different conditions of wear. The samples were arranged such that there were edge fibre separation angles of θ_{edge}=0°, 45°, 90° and 135°, wherein θ_{edge} is the edge fibre separation angle of the top layer.

It is commonly known that tool wear is an essential reason for the formation of delaminations in the stock removing machining of fibre composite materials.

Increasing blade radius leads to an increase of the removal forces and makes the defined separation of the fibres difficult. Whereas the delaminations at beginning wear are essentially restricted to fibre overhang, even break-outs and spallings of the top layer occur upon further proceeding wear. However, in the case of small blade rounding, the fibres are separated completely.

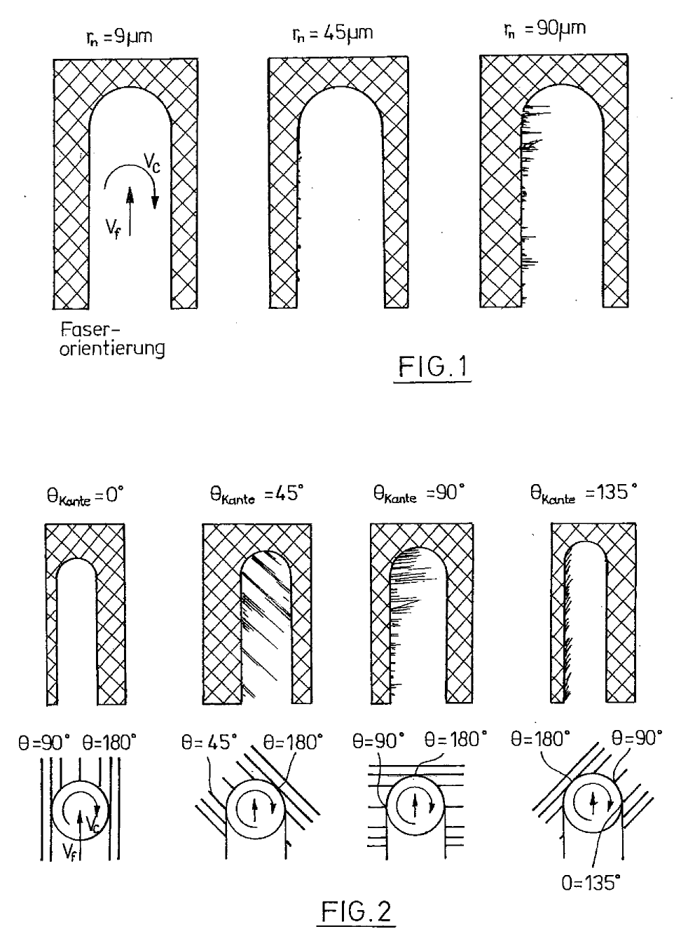

FIG. 1 shows a milled slit upon increasing wear of the tool. FIG. 1a shows a good quality of the machined edges for a blade rounding rₙ of rₙ=9 μm and a fibre orientation vertical to the produced edges (edge fibre separation angle θ_{edge}=90°) and a clockwise rotating tool. With increasing rounding of rₙ=45 μm protruding fibres already occur at the slit end. Upon further increasing rounding of the tool of rₙ=90 μm, the effect of delamination can be clearly recognized along the left machined edge.

FIG. 2 shows the delamination when it is milled with a worn tool (rₙ=90 μm). It can be clearly recognized that delamination and overhanging fibre ends occur with the worn tool at edge fibre separation angles of θ_{edge}=0°, θ_{edge}=45°, θ_{edge}=90° and θ_{edge}=135°. The respective orientation of the fibres is indicated by dashes at the upper left corner of the work piece in FIG. 2.

The present invention is based on the finding that the fibre separation angle θ is a decisive factor for the occurrence of delamination. The fibre separation angle is that angle which is spanned by the cutting direction and the orientation of the fibres. Due to the circular movement in the milling, the cutting direction changes during the cutting engagement, and with it also the fibre separation angle.

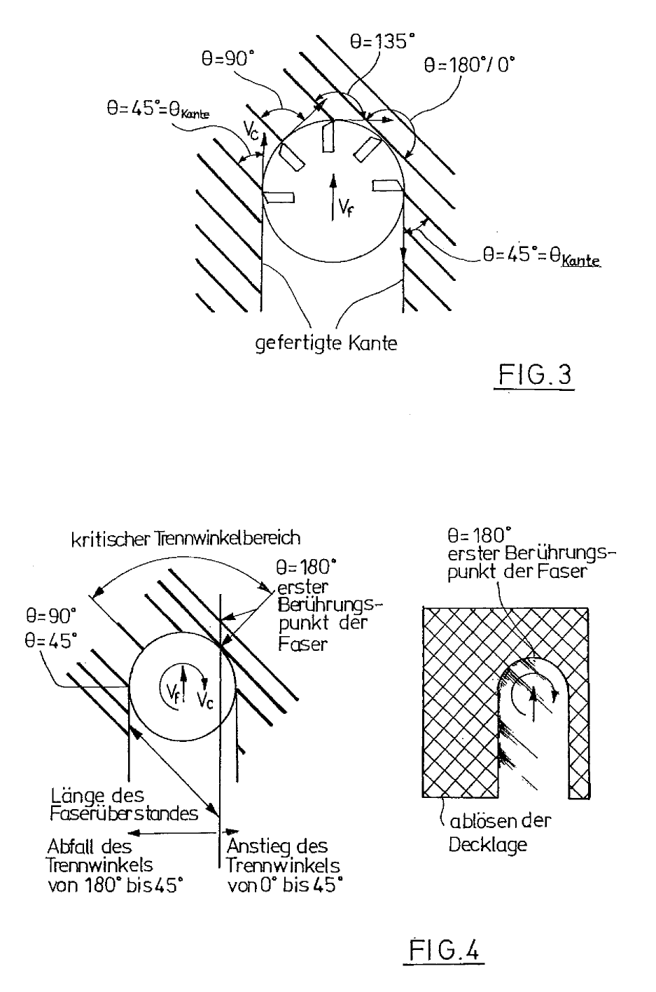

FIG. 3 shows a change of the fibre separation angle by way of example of the milling with an edge fibre separation angle of θ=θ_{edge}=45°. It can be clearly recognized that there is an edge fibre separation angle of 45° at 9 o'clock. At 12 o'clock occurs a fibre separation angle of 135°, which is not an edge fibre separation angle, however. At 3 o'clock, we have a fibre separation angle of 45° again.

When contemplating FIG. 2, it becomes clear that upon machining with an edge fibre separation angle of θ_{edge}=90°, delaminations occur only there where the fibres had been separated under a fibre separation angle between θ=90° and θ=180°. At the same time, areas occur that are free of delamination. The same can be observed for the remaining fibre orientations. According to this, when the fibre separation angle is regarded, it can be drawn the conclusion that delaminations arise only in a fibre separation angle range between 90° and 180°.

But when FIG. 2 is analysed more accurately, one detects that at fibre orientation of θ_{edge}=45°, delaminations can occur even outside of the critical range.

For instance, the machined left edge as well as the slit end is damaged by fibres that stand out. On the other hand, at fibre orientation below the edge fibre separation angle of θ_{edge}=135°, one detects that an area of the slit end is free of delaminations, whereas the edges machined in synchronisation as well as those machined in cut-up have delaminations with projecting fibres.

Thus, the present invention is based on the second finding that besides to the edge fibre separation angle as depicted in FIG. 3, the propagation of the delaminations in the work piece is decisive for the quality of the edge.

The mechanism for the rise and the propagation of delaminations can be reconsidered in more detail in FIG. 4. In the depicted realisation example, the faultless fibre is hit at approximately 2 o'clock and in a fibre separation angle of 180° at first. This means that in the slit end, the fibres are machined in an angle range of approximately 10 o'clock to 2 o'clock with a fibre separation angle of more than 90°. According to the present invention, it has now been found that this first machining of the fibres leads to damage of the fibres in the matrix, which have also an effect on a subsequent machining of the fibres. As FIG. 4 shows in the area of the slit end, even at edge fibre separation angle of θ_{edge}=45°, projecting fibres occur on the edge that is machined in up-cut.

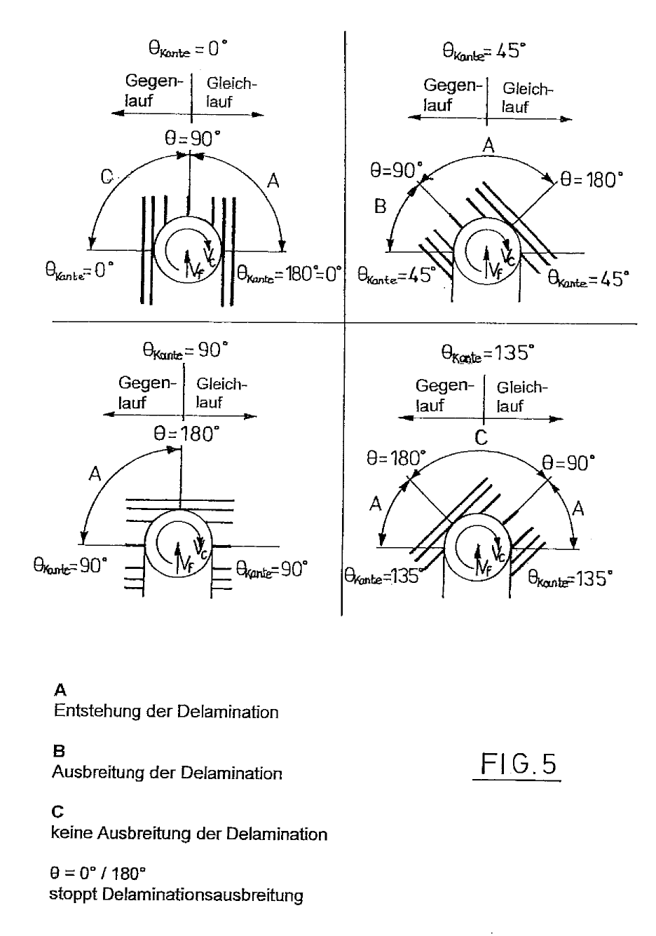

The previous explanations are systematically summarized in FIG. 5 for the edge fibre separation angles θ_{edge}=0°, θ_{edge}=45°, θ_{edge}=90° and θ_{edge}=135°. In this, the range A designates the critical range of fibre separation angles, in which delaminations can arise. Due to the fibre separation angle, no delaminations can occur in the range C.

In the fibre orientation below the edge fibre separation angle of θ_{edge}=45°, the propagation of delaminations occurs in the angle range B, which have arisen once before in a range A. But in this it is clear that the critical range B, in which the propagation of the delamination takes place, occurs only at the edge machined in up-cut, and is not found at the edge machined in synchronisation.

In the same way, delaminations can occur under the edge fibre separation angle of θ_{edge}=90° in the range A at the edge machined in up-cut, whereas the edge machined in synchronisation is free of delaminations.

In fact, in a fibre orientation below the edge fibre separation angle of θ_{edge}=135°, no propagation of the delaminations occurs in the angle range C, but both edges are in the critical fibre separation angle range, so that delaminations occur on the edge machined in up-cut as well as on that machined in synchronisation.

As a summary, FIG. 5 makes clear that besides to the condition of the edge fibre separation angle to be in the range of 0°≦θ_{edge}≦90°, the component edge must also be milled in synchronisation in order to be free of delaminations.

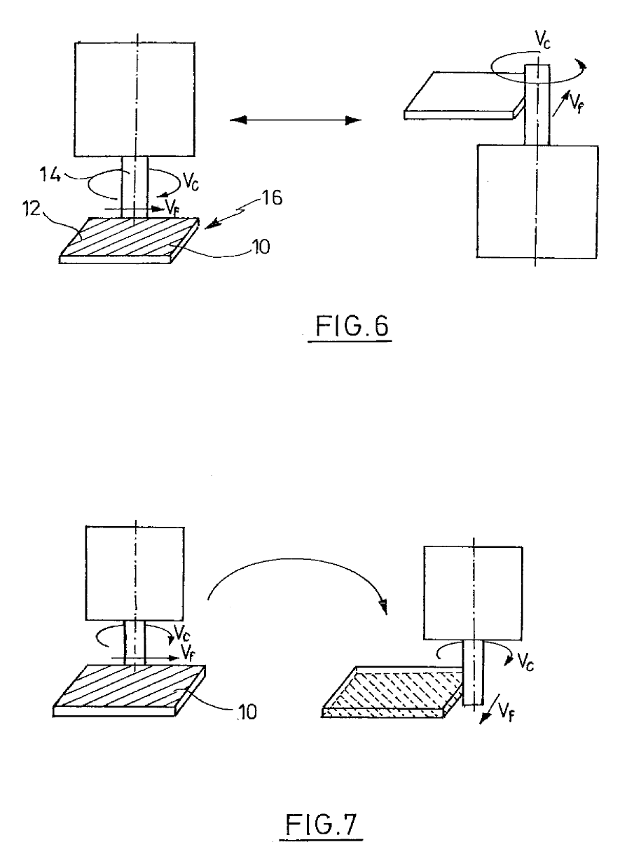

On the example of a squared work piece, FIG. 6 shows how the machining of the work piece according to the present invention can be ensured by changing the spindle arrangement. In its left part, FIG. 6 shows a work piece 10 in a perspective view. The machining side of the work piece 10 at the rear in FIG. 6 is machined by a tool 14, that works by rotation to the right (clockwise) with v_{c}, wherein the fibres 12 at the rear work piece edge are oriented under 45° to the cutting direction. The advancing direction v_{f} selected for milling the produced work piece edge in synchronisation is indicated by a vector. In the left part of FIG. 6, one recognizes that there is an edge fibre separation angle of θ_{edge}=45° with respect to the edge of the top layer depicted in the figure.

In order to machine the face of the work piece 10 indicated by 16, the spindle arrangement can be reversed, so that a clockwise rotating tool is also used along the side edge 16. Thus, for the edge of the tool 10 at the side face 16, the condition that the edge fibre separation angle is <90° can be maintained again. Moreover, it results from the advancing direction depicted at the right side of FIG. 6 that machining in synchronisation takes place again.

FIG. 7 shows an alternative variant in which not the spindle arrangement is changed, but the work piece 10 is reversed. The fibres 12 of the top layer are situated on the topside of the work piece 10 in FIG. 7, whereas the work 10 piece has been reverted in the right side of FIG. 7, so that the top layer of the work piece 10 situated at the upper side in FIG. 7 is now downside in the right side of FIG. 7.

Normally, the work pieces to be machined are configured symmetrically with respect to the fibre orientation of the top layer. This means that that the fibre orientation present at the one side of the work piece is also present at the opposite side. Thus, in a symmetrically configured work piece it is not necessary to discriminate between the edges of the upper and the lower top layer with respect to a cutting face. When the conditions for an upper top layer are fulfilled, this is automatically also the case for the lower top layer.

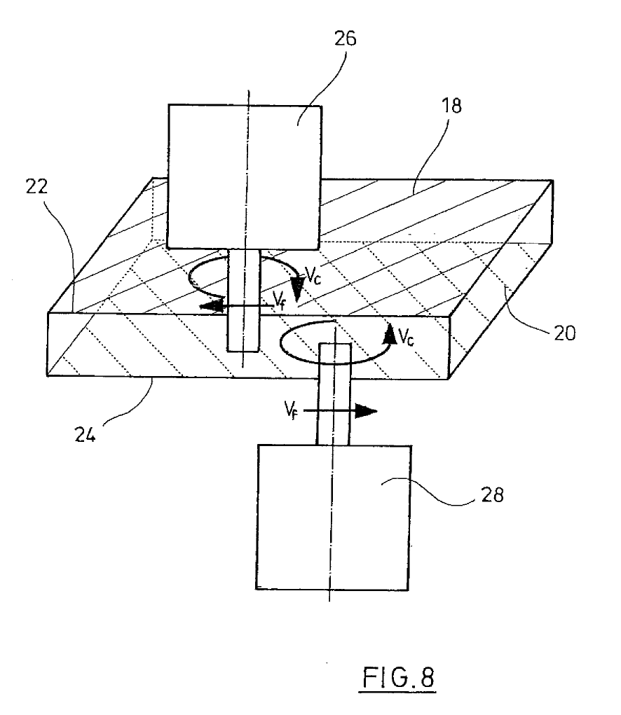

FIG. 8 shows a work piece which has an upper top layer 18 and lower top layer 20 depicted in dashes. The fibre orientations of the top layers 18 and 20 encompass an angle of 90°, so that it is not possible to machine the upper work piece edge 22 in common with the lower workpiece edge 24. Therefore, the realisation example depicted in FIG. 8 proposes to machine the upper work piece edge 22 and the lower work piece edge 24 with opposite cutting directions, by selecting opposite spindle arrangements 26 or 28, respectively, and with opposite advancing directions vᵣ.

This completes the description of the preferred and alternate embodiments of the invention. Those skilled in the art may recognize other equivalents to the specific embodiment described herein which equivalents are intended to be encompassed by the claims attached hereto.

1. A method for milling long fibre reinforced composite plastics having at least one unidirectional top layer using a rotating milling tool, wherein work piece and tool are moved in an advancing movement parallel to the work piece cutting face relative to each other, wherein
there is an edge fibre separation angle on the work piece of 0°≦θ_{edge}≦90°, and
the blade of the tool mills the component edge in synchronization.

2. The method according to claim 1, wherein that the milling takes place with the addition of a coolant.

3. The method according to claim 2, wherein that the coolant is added in a liquid and/or gaseous form.

4. A method according to claim 2, wherein that the coolant is added in the form of an exhalation.

5. A method according to claim 1, wherein areas are discriminated for a work piece edge to be milled, such that the edge fibre separation angle is 90° at the transitions of the areas, and the cutting direction and the advancing direction are selected for each area such that the edge fibre separation angle θ_{edge} is always 0°≦θ_{edge}≦90° and the work piece edge is produced in synchronization.

6. A method according to claim 1, wherein a clockwise rotating tool and a counter-clockwise rotating tool are arranged in a tool spindle, wherein the cutting direction and the advancing direction are selected such that for work piece edges having areas of different fibre orientation, always the tool having the suitable rotational direction is used, by which the admissible range of the edge fibre separation angle is maintained and the work piece edge is always milled in synchronization.

7. A method according to claim 1, wherein areas are discriminated for a component edge to be milled, such that the edge fibre separation angle is 90° at the transitions of the areas, and that the cutting direction and the advancing direction are selected for each area such that the edge fibre separation angle θ is always 0°≦θ_{edge}≦90° by reversing the spindle arrangement or the component between the areas, and that the work piece edge is produced in synchronization.
